(19) United States
(12) Patent Application Publication
(10) Pub. No.: US 2014/0278720 A1
(43) Pub. Date: Sep. 18, 2014

(54) WORKFLOW GENERATION SUPPORTING APPARATUS

(71) Applicant: FUJI XEROX CO., LTD., Tokyo (JP)

(72) Inventor: Ryouji TAGUCHI, Kanagawa (JP)

(73) Assignee: FUJI XEROX CO., LTD., Tokyo (JP)

(21) Appl. No.: 13/972,116

(22) Filed: Aug. 21, 2013

(30) Foreign Application Priority Data
Mar. 12, 2013 (JP) 2013-049574

(51) Int. Cl. G06Q 10/06

(52) U.S. Cl. CPC G06Q 10/06316
USPC 705/7.26

(57) ABSTRACT

A workflow generation supporting apparatus includes a unit extracting difference information between old and new work rules documents; a unit obtaining association information between configuration information of the old work rules document and steps of a workflow of the old work rules document; and a supporting unit supporting generation of a workflow of the new work rules document by presenting a step to be changed in the workflow of the old work rules document based on the difference information and the association information. When the difference information includes an added configuration, the supporting unit compares the layers in terms of the logical configuration of the added configuration and an immediately previous step, and, when the layer of the added configuration is lower than the layer of the immediately previous step, presents the immediately previous step as a step to be changed in the workflow of the old work rules document.

### CROSS-REFERENCE TO RELATED APPLICATIONS

This application is based on and claims priority under 35 USC 119 from Japanese Patent Application No. 2013-049574 filed Mar. 12, 2013.

### BACKGROUND

(i) Technical Field

The present invention relates to a workflow generation supporting apparatus.

(ii) Related Art

Hitherto, systems for lessening the burden in editing wording to be displayed in association with each task of a workflow on the basis of work rules or work manuals have been proposed.

By the way, work rules documents such as work rules or work manuals are necessary to be changed as needed. For example, at a financial institution, it becomes necessary to change its work rules document every time a notice is given from the Financial Services Agency. In this case, every time the work rules document is changed, a person in charge is required to manually check which part of the work rules document has been changed in what way, and further, the person in charge is required to manually determine which part of a workflow corresponding to the work rules document is to be changed in what way in accordance with the change(s) of the work rules document. The workload may be lessened to some extent by automatically generating link information to display wording to be displayed in association with a task. However, the fact remains that the person in change is required to manually determine in what way the workflow is to be changed in accordance with the changed part(s) of the work rules document. It is therefore desired to further lessen the workload.

### SUMMARY

According to an aspect of the invention, there is provided a workflow generation supporting apparatus including an extracting unit, an obtaining unit, and a supporting unit. The extracting unit extracts difference information between an old work rules document and a new work rules document. The obtaining unit obtains association information between configuration information of the old work rules document and steps of a workflow of the old work rules document. The supporting unit supports generation of a workflow of the new work rules document by presenting a step to be changed in the workflow of the old work rules document on the basis of the difference information and the association information. When the difference information includes a configuration newly added in the new work rules document, the supporting unit compares the layer in terms of the logical configuration of the added configuration with the layer in terms of the logical configuration of a step immediately prior to the added configuration, and, when the layer in terms of the logical configuration of the added configuration is lower than the layer in terms of the logical configuration of the immediately previous step, the supporting unit presents the immediately previous step as a step to be changed in the workflow of the old work rules document.

### BRIEF DESCRIPTION OF THE DRAWINGS

An exemplary embodiment of the present invention will be described based on the following figures, wherein:

FIG. 1 is a conceptual diagram of a workflow generation supporting apparatus according to an exemplary embodiment;

FIG. 2 is a block diagram showing the configuration of the workflow generation supporting apparatus according to the exemplary embodiment;

FIGS. 3A and 3B are an explanatory diagram of a work rules document and its configuration information;

FIG. 4 is an explanatory diagram of the association between the configuration information of the work rules document and a flow configuration;

FIG. 5 is a flowchart of a process according to the exemplary embodiment;

FIG. 6 is an explanatory diagram of a screen presenting a step to be changed; and

FIG. 7 is an explanatory diagram of a screen presenting a step to be changed.

### DETAILED DESCRIPTION

Hereinafter, an exemplary embodiment of the invention will be described in detail with reference to the drawings.

FIG. 1 is a conceptual diagram of a workflow generation supporting apparatus according to the exemplary embodiment. The workflow generation supporting apparatus according to the exemplary embodiment supports the user in, when a work rules document regulating the content of work is changed from an old one to a new one, generating a new workflow corresponding to the new one. In order to simplify the diagram shown in FIG. 1, a work rules document and a workflow are simply referred to as a “rules document” and a “flow”, respectively. In the present embodiment, a “rule” generally refers to regulating the condition or way of a thing as a certain form, or regulation thereof. Meanwhile, there is a similar word, namely, a “code”, which generally refers to the package of a series of provisions defined for a particular purpose. In the Specification, a work rules document is defined with the former meaning. However, there is no technical difference between the two meanings, and the exemplary embodiment is similarly applicable to a work rules document having the latter meaning, and application to a code of work rules shall not be excluded. When the two meanings are strictly distinguished, for example, application is possible by reading, for example, a rules document as “a code of work rules”, and reading each task included in the code of work rules as a “rule”.

Referring to FIG. 1, it is assumed that there are an old rules document 12, an old flow 10 corresponding to the old rules document 12, and a new rules document 18.

The workflow generation supporting apparatus includes, as its functional blocks, a rules document configuration extracting unit 14, a rules-document-configuration-and-flow-configuration associating unit 16, a rules document configuration difference extracting unit 20, and a flow configuration change draft generating unit 22. The old flow 10, the old rules document 12, and the new rules document 18 exist as documents, and these documents may be digitized as needed and may be stored in a memory of the workflow generation supporting apparatus.

The rules document configuration extracting unit 14 extracts, on the basis of text data of the old rules document 12, a hierarchical structure in terms of the logical configuration of sentences included in the text data. Here, the hierarchical structure of sentences refers to a structure including a chapter(s), a section(s), a subsection (s), and the like, which are included in the sentences. Sentences generally have a logical structure, which forms a hierarchical structure including a chapter or chapters, each chapter including a section or sections, and each section including a subsection or subsections. In other cases, there are no wording such as “chapter”, “section”, “subsection”, or the like, and, instead, Arabic numerals are used to express a structure such as below:

1. XX

1.1 YY

1.1.1 ZZ

1.1.2 ZZ

1.2 YY

2. XX

In this case, “1.” and “2.” correspond to chapters, “1.1” and “1.2” correspond to sections, and “1.1.1” and “1.1.2” correspond to subsections. Using text data such as these “chapters”, “sections”, “1.”, “1.1”, and the like; the rules document configuration extracting unit 14 extracts the hierarchical structure of the old rules document 12. The rules document configuration extracting unit 14 outputs the extracted rules document configuration information to the rules-document-configuration-and-flow-configuration associating unit 16. Also, data of the old flow 10 is supplied to the rules-document-configuration-and-flow-configuration associating unit 16.

The rules-document-configuration-and-flow-configuration associating unit 16 associates the rules document configuration information with each step (or task) of the old flow 10. Specifically, in response to an operation performed by the user to give an instruction to associate each piece of the rules document configuration information with a corresponding step of the corresponding old flow 10, the rules-document-configuration-and-flow-configuration associating unit 16 associates each piece of the rules document configuration information with each step of the old flow 10. For example, the rules document configuration information and the old flow 10 are displayed in parallel with each other for comparison on a screen of a display device, and the user uses an input device such as a mouse to associate each piece of the rules document configuration information with a corresponding step of the old flow 10 by specifying the two. The rules-document-configuration-and-flow-configuration associating unit 16 holds, in a memory, the associated rules document configuration and flow configuration as a combination. The rules-document-configuration-and-flow-configuration associating unit 16 may display the associated rules document configuration and flow configuration on the display device in a manner that the user is able to visually recognize the corresponding relationship between the two. This will be described later. The rules-document-configuration-and-flow-configuration associating unit 16 outputs the association information between the two to the flow configuration change draft generating unit 22.

Meanwhile, the text data of the old rules document 12 and the text data of the new rules document 18 are both supplied to the rules document configuration difference extracting unit 20.

The rules document configuration difference extracting unit 20 compares the text data of the old rules document 12 with the text data of the new rules document 18 and extracts the difference, that is, a dissimilar part between the old rules document 12 and the new rules document 18. A dissimilar part is at least any one of a part of the old rules document 12 that has been changed in the new rules document 18, a part of the old rules document 12 that has been deleted in the new rules document 18, and a part that has been added in the new rules document 18. The rules document configuration difference extracting unit 20 outputs the extracted difference information to the flow configuration change draft generating unit 22.

The flow configuration change draft generating unit 22 generates a new flow 24 corresponding to the new rules document 18 on the basis of the rules-document-configuration-and-flow-configuration association information and the difference information. More specifically, the flow configuration change draft generating unit 22 generates, on the basis of the difference information, a candidate for a step to be changed in the old flow 10 or a candidate indicating to which part of the old flow 10 a new step should be added, by referring to the rules-document-configuration-and-flow-configuration association information. On the basis of the difference information, the flow configuration change draft generating unit 22 specifies a part that has been newly changed, deleted, or added in the new rules document 18, and pays attention to the hierarchical relationship in terms of the logical configuration between the specified part and a part immediately prior to the specified part in the old flow 10. In accordance with the hierarchical relationship in terms of the logical configuration with the immediately previous part, the flow configuration change draft generating unit 22 generates a change draft as to how the part is to be changed in the old flow 10.

The basic principle for generating a candidate by the flow configuration change draft generating unit 22 is that, when a part has been changed, a corresponding step of the old flow 10 is changed in accordance with the wording of the new rules document 18; when a part has been deleted, a corresponding step of the old flow 10 is deleted; and, when a part has been added, a step of the added part is determined in accordance with the hierarchical relationship in terms of the logical configuration with the immediately previous part.

That is, the flow configuration change draft generating unit 22 pays attention to the hierarchical relationship in terms of the logical configuration between the added part and the immediately previous part, and, if the layer of the added part is lower (that is, smaller) than the layer of the immediately previous part, the relationship is that the added part is included in the immediately previous part. Thus, a step of the added part in the new flow 24 is regarded as part of the immediately previous step in the old flow 10, and this addition is handled by changing the immediately previous step. Alternatively, if the layer in terms of the logical configuration of the added part is the same as the layer in terms of the logical configuration of the immediately previous part, the added part is located beside the immediately previous part. Thus, a step of the added part in the new flow 24 is handled by adding a new step next to the immediately previous step in the old flow 10. Further, if the layer in terms of the logical configuration of the added part is higher (that is, greater) than the layer in terms of the logical configuration of the immediately previous step, because a step of the added part in the new flow 24 is hierarchically higher, it is inappropriate to simply add this step as it is next to the immediately previous step. Therefore, the layer in terms of the logical configuration of the added part is decomposed into pieces until the layer thereof becomes the same level as the layer in terms of the logical configuration of the immediately previous part, and new steps, the number of which is the number of decomposed pieces, are sequentially added next to the immediately previous step in the old flow 10.

The flow configuration change draft generating unit 22 displays the generated change draft on the display device and presents the change draft to the user. The user appropriately refers to the displayed change draft and finally generates the new flow 24 corresponding to the new rules document 18.

FIG. 2 shows the hardware configuration of the workflow generation supporting apparatus according to the exemplary embodiment. The workflow generation supporting apparatus includes an input unit 30, a central processing unit (CPU) 32, a communication controller 34, an output unit 36, a program memory 38, a rules document storage memory 40, and a flow storage memory 42.

The input unit 30 is a mouse, a keyboard, a keypad, or the like, and inputs an instruction given from the user.

The output unit 36 is a display device such as a liquid crystal display. The output unit 36 displays a rules document or rules document configuration information and a flow in parallel with each other, and displays a changed part, a candidate for a new flow, or the like.

The rules document storage memory 40 stores the old rules document 12 and the new rules document 18. The old rules document 12 and the new rules document 18 may exist as image data read by a scanner or the like, or may exist as text data.

The CPU 32 reads a processing program stored in the program memory 38, and executes a new flow generation supporting process, which will be described later, by sequentially executing the processing program. The CPU 32 functions as the rules document configuration extracting unit 14, the rules-document-configuration-and-flow-configuration associating unit 16, the rules document configuration difference extracting unit 20, and the flow configuration change draft generating unit 22 shown in FIG. 1, and executes a process of extracting rules document configuration information from the old rules document 12, a process of generating rules-document-configuration-and-flow-configuration association information from the old flow 10 and the rules document configuration information, a process of extracting a difference by comparing the old flow 10 and the new flow 24, and a process of generating a flow configuration change draft by using the rules document configuration information and the rules-document-configuration-and-flow-configuration association information and presenting the flow configuration change draft.

The communication controller 34 transmits and receives data to and from an external server via a network as needed. The old flow 10, the old rules document 12, and the new rules document 18 may be received from the external server via the communication controller 34, and may be stored in the rules document storage memory 40 and the flow storage memory 42. Also, the CPU 32 may execute some of the above-described processes by cooperating with the external server. In this case, the external server functions as part of the workflow generation supporting apparatus, together with the CPU 32.

The rules document storage memory 40 and the flow storage memory 42 may not necessarily be separate memories and may be a single integrated memory. A rules document and a flow may both be stored in the external server. Every time an occasion arises, the CPU 32 may receive a necessary rules document and a necessary flow from the external server and may perform processing.

FIG. 3 schematically shows a process of extracting rules document configuration information from the old flow 10. FIG. 3(a) shows the old rules document 12, and FIG. 3(b) shows rules document configuration information extracted from the old rules document 12. A rules document generally has a hierarchical structure including a chapter(s), a section(s), and a sub-section(s) in consideration of the visibility and understandability. FIG. 3(a) follows this practice. In FIG. 3(a), it is assumed that there are chapters “1. Task A” and “2. Task B”; there are “1.1 Task A-1” and “1.2 Task A-2” below “1. Task A”; and there are “2.1 Task B-1” and “2.2 Task B-2” below “2. Task B”.

Meanwhile, FIG. 3(b) shows the rules document configuration information, which is extracted with the above-described hierarchical structure. That is, “1. Task A” and “2. Task B” are extracted as chapters; “1.1 Task A-1” and “1.2 Task A-2” exist in parallel on the same layer as sections below the chapter “1. Task A”; and “2.1 Task B-1” and “2.2 Task B-2” exist in parallel on the same layer as sections below the chapter “2. Task B”. Special identifiers may be given to the chapters and sections, and the connecting relationship between each of the chapters and a corresponding section may be represented as a link.

FIG. 4 schematically shows a process of associating a rules document configuration with a flow configuration. FIG. 4 shows an exemplary screen displayed on the screen of the display device serving as the output unit 36 of the workflow generation supporting apparatus. The rules document configuration information of the old rules document 12 is displayed on the left of the screen, and the old flow 10 is displayed in parallel on the right of the screen. By viewing and recognizing the screen, the user is able to contrast the rules document configuration information of the old rules document 12 with the old flow 10, and to confirm the relationship between each configuration of the rules document configuration information and each step of the old flow 10. When the user operates the mouse serving as the input unit 30 and selects a particular configuration of the rules document configuration information, the selected configuration is displayed in highlight, and a description of the selected configuration is displayed in the lower left-hand corner of the screen. In FIG. 4, the use selects “2.1 Task B-1” from the rules document configuration information, and a description thereof, that is, content of the task B-1, is displayed. Next, the user views and recognizes the old flow 10 displayed in parallel on the right of the screen, and, with the mouse, selects a corresponding step of the old flow 10 that corresponds to the configuration selected from the rules document configuration information. In FIG. 4, it is shown that the user selects “Step B-1” as a corresponding step of the old flow 10 that corresponds to “2.1 Task B-1” of the rules document configuration information. The selected step is displayed in highlight. Also, a description of the selected step is displayed in the right-hand corner of the screen.

When the user selects a particular configuration from the rules document configuration information and a corresponding step of the old flow 10, the selected configuration and the step are associated with each other, and a link indicating that the selected configuration and the step are associated with each other is displayed as a broken line on the screen. Similarly, “1. Task A” of the rules document configuration information and “Step A” of the old flow 10, and “2.2 Task B-2” of the rules document configuration information and “Step B-2” of the old flow 10 are associated with each other, and links indicating that the two are associated with each other are displayed as broken lines.

In the above manner, association information is generated as follows:

“1. Task A” - - - “Step A”

“2.1 Task B-1” - - - “Step B-1”

“2.2 Task B-2” - - - “Step B-2”

Using this Information and the Difference Information, a Candidate for Generating a New Flow is Generated.

FIG. 5 is a flowchart of a process according to the exemplary embodiment. Prior to this process, it is assumed that the CPU 32 has extracted rules document configuration information from the old rules document 12, generated rules-document-configuration-and-flow-configuration association information from the rules document configuration information and the old flow 10, and stored the generated rules-document-configuration-and-flow-configuration association information in a memory, as has been described with reference to FIGS. 3 and 4.

Firstly, the CPU 32 sequentially compares, from the beginning, the configuration information of the old rules document 12 and of the new rules document 18 in order to extract difference information between the old and new rules documents 12 and 18 (S101). That is, the CPU 32 additionally extracts the rules document configuration information from the new rules document 18, as has been done with the old flow 10, sequentially contrasts, from the beginning, the rules document configuration information of the old rules document 12 with the rules document configuration information of the new rules document 18, and determines the similarities and dissimilarities between the two. A configuration changed in the new rules document 18, a configuration deleted in the new rules document 18, and a configuration added in the new rules document 18 are extracted.

Next, the CPU 32 determines whether there exists a configuration added in the new rules document 18 (S102). When there exists no configuration added in the new rules document 18, that is, when there exists only a changed or deleted configuration, it is only necessary to change the wording of a step of the old flow 10 that corresponds to the changed configuration or to delete a step of the old flow 10 that corresponds to the deleted configuration. Thus, a draft for changing or deleting the corresponding step is simply presented as a candidate for the new flow 24.

When there exists a configuration added in the new rules document 18, the CPU 32 then determines whether the layer in terms of the logical configuration of the added configuration is lower than the layer in terms of the logical configuration of the immediately previous step (S103). Since the rules document configuration information of the new rules document 18 has already been extracted, and the position where the added configuration exists in the rules document configuration information is specified, the configuration immediately prior to the added configuration is also specified from the rules document configuration information. The rules document configuration information and the flow configuration of the old flow 10 have already been associated with each other and stored in a memory. A layer in terms of the logical configuration means a chapter, a section, a sub-section, or the like. A chapter and a chapter, a section and a section, and a sub-section and a sub-section are on the same layer in terms of the logical configuration. A chapter is higher than a section in terms of the logical configuration, and a section is higher than a sub-section in terms of the logical configuration. In other words, a section is lower than a chapter in terms of the logical configuration, and a sub-section is lower than a chapter or a section in terms of the logical configuration. If the layer of the added configuration is lower than the layer of the immediately previous step, it means that a corresponding part of the old rules document 12 is described in more detail in the new rules document 18. Thus, the added configuration is regarded as part of the immediately previous step in the old flow 10, and the immediately previous step is displayed in highlight, and a change draft is presented (S107).

In contrast, if the added configuration is not lower than the layer of the immediately previous step, the CPU 32 then determines whether the added configuration is on the same layer as the immediately previous step (S104). If the added configuration is on the same layer as the immediately previous step, it means that content on the same level as a corresponding part of the old rules document 12 has been additionally described in the new rules document 18. Thus, a new step is generated next to the immediately previous step, the new step is displayed in highlight, and a change draft is presented (S106).

Alternatively, if the added configuration is not lower than the layer of the immediately previous step and if the added configuration is not on the same layer as the immediately previous step, that is, if the added configuration is higher than the layer of the immediately previous step, it means that a chapter, a section, or the like that is higher than a corresponding part of the old rules document 12 has been additionally described in the new rules document 18. Thus, the added configuration is decomposed into pieces on the same layer as the immediately previous step, new steps, the number of which is the number of decomposed pieces, are generated next to the immediately previous step; the generated new steps are displayed in highlight, and a change draft is presented (S105). For example, if the added configuration is a chapter and if the immediately previous step is a section, the added chapter is decomposed into pieces on the section level. If there are five sections obtained as a result of decomposition, five new steps are generated next to the immediately previous step, and the result is presented as a change draft. With reference to FIG. 4, on the assumption that “3. Task C” is newly added to the old rules document 12 in the new rules document 18, and task C includes four tasks C-1, C-2, C-3, and C-4 as sections, four new steps are generated next to “Step B-2”, which is the immediately previous step, and a change draft in which “C-1”, “C-2”, “C-3”, and “C-4” are assigned to the four new steps, respectively, is generated and presented. To decompose the added configuration into pieces on the same layer as the immediately previous step, it is not only necessary that the hierarchical structure of the added configuration be analyzed, but also the algorithm of extracting rules document configuration information may be used as it is.

FIG. 6 shows an example of a screen generating and presenting a change draft in the case of a changed configuration. This is the processing in the case where it is determined NO in step S102 in FIG. 5. The rules document configuration information of the new rules document 18 is displayed on the left of the screen, and a draft for the new flow 24 is displayed on the right of the screen. When the changed configuration is “2.1 Task B-1”, the CPU 32 displays in highlight the corresponding configuration “2.1 Task B-1” of the rules document configuration information. Meanwhile, since “2.1 Task B-1” and “Step B-1” in the old flow 10 are associated with each other, the CPU 32 displays in highlight “2.1 Task B-1”, and simultaneously displays in highlight “Step B-1” associated with “2.1 Task B-1”. A broken line is displayed between “2.1 Task B-1” and “Step B-1” to show that the two are associated with each other. Accordingly, the user is capable of easily recognizing that the step that corresponds to the changed configuration is “Step B-1”, and, with this recognition, amends the wording of step B-1 in accordance with the wording of the new rules document 18, thereby easily generating the new flow 24.

Alternatively, the CPU 32 may not only display in highlight “Step B-1”, but may also automatically amend the wording of “Step B-1” by referring to the rules document configuration information of the new rules document 18, and may present the amended “Step B-1” as a change draft for the new flow 24. In this case, it is preferable to display the changed wording in the lower right-hand corner of the screen.

FIG. 7 shows an example of a screen generating and presenting a change draft in the case of a deleted configuration and in the case of an added configuration. As in FIG. 6, the rules document configuration information of the new rules document 18 is displayed on the left of the screen, and a draft for the new flow 24 is displayed on the right of the screen. When the deleted configuration is “1.2 Task A-2”, the CPU 32 displays in highlight the deleted configuration, and presents a change draft generated by deleting, from the new flow 24, a step associated with “1.2 Task A-2” in the old flow 10. In FIG. 7, since there is no step associated with “1.2 Task A-2”, the screen remains as it is. Since the step immediately prior to “1.2 Task A-2” is “Step A”, this “Step A” may be displayed in highlight to prompt the user to make an amendment.

When the added configuration is “2.3 Task B-3”, the CPU 32 displays in highlight the added configuration, and compares the layer of the added configuration with the layer of a step immediately prior to “2.3 Task B-3”. In this case, the layer of the added configuration and the layer of the immediately previous step are the same. Thus, it is determined YES in step S104 in FIG. 5, and, accordingly, a change draft is generated by adding “Step Task B-3” as a new step next to “Step B-2”, which is the immediately previous step, and the change draft is presented.

The above processing will be more specifically described.

It is assumed that the old rules document 12 is as follows:

1. Acceptance
1.1 To describe XX
1.2 To confirm XX

2. Document reception
2.1 To receive XX
2.2 To confirm XX
2.3 To send to XX, and
   the new rules document 18 is as follows:

1. Acceptance
1.1 To describe XX
1.2 To confirm XX

2. Document reception
2.1 To receive XX
2.2 To confirm XX
2.3 To send to XX
2.4 To receive from XX.
   The added configuration is
“2.4 To receive from XX”.
   Since the layer in terms of the logical configuration of the added configuration and the layer in terms of the logical configuration of the immediately previous step are the same, the CPU 32 generates a new step next to a step associated with “2.3 To send to XX” in the old flow 10, and presents this as a change draft on the screen. Further, the content of “2.4 To receive from XX” may be assigned to this step.

Also, it is assumed that the new rules document 18 is as follows:

1. Acceptance
1.1 To describe XX
1.2 To confirm XX

2. Document reception
2.1 To receive XX
2.2 To confirm XX
2.3 To send to XX, and
2.3.1 To confirm XX.
   The added configuration is
“2.3.1 To confirm XX”.
   Since the layer in terms of the logical configuration of the added configuration is lower than the layer in terms of the logical configuration of the immediately previous step, the CPU 32 displays in highlight a step associated with “2.3 To send to XX” in the old flow 10, and presents that this step should be changed. Further, the content of “2.3.1 To confirm XX” may be additionally written in this step.

Also, it is assumed that the new rules document 18 is as follows:

1. Acceptance
1.1 To describe XX
1.2 To confirm XX

2. Document reception
2.1 To receive XX
2.2 To confirm XX
2.3 To send to XX

3. Data input
3.1 To confirm XX
3.2 To input XX.
   The added configuration includes

“3. Data input
3.1 To confirm XX
3.2 To input XX.”
   Since the layer in terms of the logical configuration of the added configuration is higher than the layer in terms of the logical configuration of the immediately previous step, the CPU 32 decomposes the added configuration until the layer in terms of the logical configuration of the added configuration becomes the same level as the layer in terms of the logical configuration of the immediately previous step. In this case, the chapter “3. Data input” is decomposed into two sections “3.1 To confirm XX” and “3.2 To input XX”, two new steps are generated next to a step associated with “2.3 To send to XX” in the old flow 10, and the result is presented as a change draft on the screen. Further, the content of “To confirm XX” and “To input XX” may be assigned to these two steps, respectively.

As described above, when difference information is extracted by comparing the old rules document 12 and the new rules document 18, and when a changed configuration exists, a deleted configuration exists, or an added configuration exists, a draft for changing the old flow 10 is generated in accordance with each of the cases, and the change draft is presented as the new flow 24. Thus, the user is capable of receiving instructions as to how to change which part of the old flow 10 in accordance with the new rules document 18, and the new flow 24 is efficiently generated.

In the above-described embodiment, when an added configuration exists, the layer in terms of the logical configuration of the added configuration is compared with the layer in terms of the logical configuration of the immediately previous step, and a change draft is generated in accordance with whether the layers are the same or different and is presented. However, there may be some variations depending on the mode of the configuration of the old flow 10 or the added configuration. Hereinafter, these variations will be described.

### When the Association Lines Between the Rules Document Configuration and the Flow Configuration Cross Each Other

Normally, the order of the rules document configuration and the order of the steps of a flow coincide with each other. However, the order of the rules document configuration may not coincide with the order of the steps of a flow, and may cross each other. For example, in FIG. 4, when the step of “2.1 Task B-1” in the flow exists subsequent to the step of “2.2 Task B-2” in the flow for some reason, “2.1 Task B-1” and “Step B-2” are associated with each other, and “2.2 Task B-2” and “Step B-1” are associated with each other. As a result, broken lines expressing the association links cross each other.

In such a case, if an added configuration exists, the CPU 32 performs processing in the same or like manner as the flowchart shown in FIG. 5. That is, the layer of the added configuration is compared with the layer of the immediately previous step. The immediately previous step in this case is a step that takes into consideration the association lines which cross each other. For example, in FIG. 7, when “2.3 Task B-3” is an added configuration, and when “2.1 Task B-1” and “Step B-2” are associated with each other and “2.2 Task B-2” and “Step B-1” are associated with each other, the immediately previous step is “Step B-1”, not “Step B-2”. When the layer of the added configuration is the same as the layer of “Step B-1”, the added configuration is regarded as part of “Step B-1”, and “Step B-1” is displayed in highlight (see S107 of FIG. 5). Alternatively, when the layer of the added configuration is lower than the layer of “Step B-1”, a new step is generated next to “Step B-1”, that is, between “Step B-1” and “Step B-2”, and the new step is displayed in highlight (see S106 of FIG. 5). Alternatively, when the layer of the added configuration is higher than the layer of “Step B-1”, the added configuration is decomposed into pieces until the layer thereof becomes the same as the layer of “Step B-1”, new steps, the number of which is the number of decomposed pieces, are generated next to “Step B-1”, and the new steps are displayed in highlight (see S105 of FIG. 5).

When there is No Step Immediately Previous to an Added Configuration

Normally, the configuration of a rules document is associated with the steps of a flow. However, the configuration of a rules document may not be associated with the steps of a flow for some reason. For example, such a case in FIG. 4 is that the flow has no step that corresponds to “2.2 Task B-2”. When “2.2 Task B-2” merely indicate remarks or the like, this task is not reflected in the flow, and thus the flow has no corresponding step.

In such a case, when an added configuration exists, because there is no step immediately prior to the added configuration, the CPU 32 moves along the rules document configuration information in the upstream direction, and searches for a configuration where there is an association with a step in the flow. For example, in FIG. 7, when “2.3 Task B-3” is an added configuration and when there is no step associated with “2.2 Task B-2”, the CPU 32 pays attention to “2.1 Task B-1”, which exists upstream of “2.2 Task B-2” in the rules document configuration information, and determines whether there is a step that corresponds to this configuration. When there is a step associated with “2.1 Task B-1”, this step is regarded as the immediately previous step, and a change draft is generated in accordance with whether the layer of the added configuration and the layer of the immediately previous step are the same or different.

### When an Added Configuration is Branched.

When an added configuration is branched, basically a change draft is generated by appropriately generating a new step in accordance with whether the layer of the added configuration and the layer of the immediately previous step are the same or different, as in the above-described exemplary embodiment. When an added configuration is branched, only the structure information of the added configuration may be insufficient for clarifying the connection destination of the branch. It is thus desirable that the user select and input the connection destination using the input unit 30 such as a mouse. For example, in FIG. 7, when “2.3 Task B-3” is an added configuration and when the configuration is such that the configuration proceeds to the next task when a certain condition is satisfied and the configuration proceeds to “Step B-1” when the certain condition is not satisfied, the user selects “Step B-1” as the connection destination of the branch. Needless to say, when the added configuration is branched, the CPU 32 may warn the user of the fact that the added configuration is branched by displaying a message indicating that on the screen, and may also display a message prompting the user to specify the connection destination of the branch. When the configuration information of the added configuration includes information on the connection destination of the branch, that step may be displayed in highlight as a candidate for the connection destination of the branch, thereby drawing attention from the user.

As described above, according to the exemplary embodiment, the old rules document 12 and the new rules document 18 are compared with each other to extract difference information, from which a changed part, a deleted part, or an added part in the new rules document 18 is specified. When an added part exists, instructions about what kind of step should be added to which part of the old flow 10 are given to the user. Accordingly, generation of the new flow 24 corresponding to the new rules document 18 becomes easier and more efficient.

Particularly in the exemplary embodiment, instructions about in which way a step corresponding to the added configuration should be added to the old flow 10 are given on the basis of the added configuration and the rules-document-configuration-information-and-flow-configuration association information. While the logical configuration of the rules document is maintained, generation of the new flow 24 is accurately supported.

In the exemplary embodiment, when the association is to be drawn between the rules document configuration information and the flow configuration, the rules document configuration information is displayed on the left of the screen, and the flow configuration is displayed in parallel on the right of the screen, as shown in FIG. 4. However, the rules document configuration information and the flow configuration are not necessarily displayed in such a way. The two may be displayed vertically on the screen, or may be displayed overlapping each other. Alternatively, only the rules document configuration information may be displayed, and the screen may be switched to the flow configuration in response to a user instruction. Note that it is desirable to have a display configuration that enables the user t easily view and recognize the association between the rules document configuration information and the flow configuration. To show the association between the rules document configuration information and the flow configuration, besides broken lines showing links, as shown in FIG. 4, any form showing that a certain configuration is associated with another configuration is usable, such as having the associated configurations in the same color, displaying the associated configurations as a pair in a table format, or displaying the associated configurations as a pair in a list format.

To draw the association between the rules document configuration information and the flow configuration, it is unnecessary to draw a one-to-one correspondence between the rules document configuration information and the flow configuration. Multiple configurations of the rules document configuration information may be associated with one step of the flow configuration, or one configuration of the rules document configuration information may be associated with multiple steps of the flow configuration. When one configuration of the rules document configuration information is associated with multiple steps of the flow configuration, there may be multiple steps immediately prior to an added configuration. In this case, there are a few processing methods. Firstly, attention is paid to any one of the multiple steps, and whether the layer of the added configuration and the layer of this step are the same or different is determined. Secondly, attention is paid to the most upstream step of the multiple steps, and whether the layer of the added configuration and the layer of the most upstream step are the same or different is determined. Thirdly, attention is paid to the most downstream step of the multiple steps, and whether the layer of the added configuration and the layer of the most downstream step are the same or different is determined. Depending on to which step attention is paid, a part where a new step corresponding to the added configuration is generated may change. Any of these processing methods may be set as a default on the apparatus side. Alternatively, the user may select any one of these processing methods.

In FIG. 7, a description of the added step corresponding to the added configuration is displayed in the lower right-hand corner of the screen. It may be configured to enable the user to edit the wording in this part by inputting text using the input unit 30. Accordingly, the new flow 24 corresponding to the new rules document 18 is more efficiently generated.

When the association is to be drawn between the rules document configuration information and the flow configuration, the association may be drawn by using a keyword in the rules document. That is, a particular keyword is selected from the rules document configuration information, the flow configuration is searched for the selected keyword, and a part of the flow configuration including the keyword is displayed in highlight as a candidate for a configuration to be associated.

When the association is to be drawn between the rules document configuration information and the flow configuration, if the rules document configuration information and the flow configuration have already been associated with each other and the association information has been stored in a memory, needless to say, it is unnecessary for the user to additionally give instructions for drawing the association between the two by using a mouse or the like. Such circumstances may occur in the case where the old rules document 12 is changed by the new rules document 18, and the new rules document 18 is changed by a new new rules document. That is, to generate a workflow corresponding to a new new rules document, because the configuration information of the new rules document 18 and the configuration of the workflow of the new rules document 18 have already been associated with each other and the association information has already been stored in a memory, the workflow generation supporting apparatus simply uses the association information already stored in the memory when supporting generation of the workflow of the new new rules document. It is unnecessary for the user to additionally give instructions for drawing the association between the two.

In the exemplary embodiment, supporting technology for generating a new workflow in response to a change of a rules document has been described. The workflow generated in such a manner may be used as a work navigation for a person working at a bank counter in the financial industry or another industry, or may also be used to manage the progress of a work.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A workflow generation supporting apparatus comprising:
an extracting unit that extracts difference information between an old work rules document and a new work rules document;
an obtaining unit that obtains association information between configuration information of the old work rules document and steps of a workflow of the old work rules document; and
a supporting unit that supports generation of a workflow of the new work rules document by presenting a step to be changed in the workflow of the old work rules document on the basis of the difference information and the association information,
wherein, when the difference information includes a configuration newly added in the new work rules document, the supporting unit compares the layer in terms of the logical configuration of the added configuration with the layer in terms of the logical configuration of a step immediately prior to the added configuration, and, when the layer in terms of the logical configuration of the added configuration is lower than the layer in terms of the logical configuration of the immediately previous step, the supporting unit presents the immediately previous step as a step to be changed in the workflow of the old work rules document.

2. A workflow generation supporting apparatus comprising:
an extracting unit that extracts difference information between an old work rules document and a new work rules document;
an obtaining unit that obtains association information between configuration information of the old work rules document and steps of a workflow of the old work rules document; and
a supporting unit that supports generation of a workflow of the new work rules document by presenting a step to be changed in the workflow of the old work rules document on the basis of the difference information and the association information,
wherein, when the difference information includes a configuration newly added in the new work rules document, the supporting unit compares the layer in terms of the logical configuration of the added configuration with the layer in terms of the logical configuration of a step immediately prior to the added configuration, and, when the layer in terms of the logical configuration of the added configuration is the same as the layer in terms of the logical configuration of the immediately previous step, the supporting unit generates and presents a new step next to the immediately previous step as a step to be changed in the workflow of the old work rules document.

3. A workflow generation supporting apparatus comprising:
an extracting unit that extracts difference information between an old work rules document and a new work rules document;
an obtaining unit that obtains association information between configuration information of the old work rules document and steps of a workflow of the old work rules document; and
a supporting unit that supports generation of a workflow of the new work rules document by presenting a step to be changed in the workflow of the old work rules document on the basis of the difference information and the association information,
wherein, when the difference information includes a configuration newly added in the new work rules document, the supporting unit compares the layer in terms of the logical configuration of the added configuration with the layer in terms of the logical configuration of a step immediately prior to the added configuration, and, when the layer in terms of the logical configuration of the added configuration is higher than the layer in terms of the logical configuration of the immediately previous step, the supporting unit decomposes the added configuration and generates and presents new steps next to the immediately previous step as steps to be changed in the workflow of the old work rules document.
